(19) United States
(12) Patent Application Publication
(10) Pub. No.: US 2005/0164674 A1
(43) Pub. Date: Jul. 28, 2005

(54) Mobile telephone fare forehead payment registration system and device

(75) Inventors: Michihiro Ota, Tokyo (JP); Hiroaki Yoshida, Tokyo (JP); Hiroaki Shinada, Tokyo (JP); Hiroki Hoshimo, Tokyo (JP); Kumiko Hisai, Tokyo (JP); Akira Onodera, Tokyo (JP)

Correspondence Address: WELSH & KATZ, LTD, 120 S RIVERSIDE PLAZA, 22ND FLOOR, CHICAGO, IL, 60606, US

(73) Assignee: KABUSHIKI KAISHA NIPPON CONLUX, TOKYO (JP)

(21) Appl. No.: 10/514,343

(22) PCT Filed: May 13, 2003
(86) PCT No.: PCT/JP03/05918

(30) Foreign Application Priority Data
May 16, 2002 (JP) 2002-141656

(51) Int. Cl. H04M 11/00

(52) U.S. Cl. 455/406; 455/408; 455/435.1

(57) ABSTRACT

A mobile telephone call fee pre-payment registration system and device capable of registering telephone call permission without requiring a complicated input operation causing erroneous input. A telephone call fee pre-payment registration device (20) performs money deposit processing for recognizing amount information (money deposit information) relating to money introduced into a money deposit processing section by a user, and performs control for obtaining identification information from the mobile telephone terminal (10) via a first communications unit (23), and sending the identification information thus obtained and the money deposit information processed by the money deposit processing unit, to a registration center device (40) via a second communications unit (24).

### TECHNICAL FIELD

The present invention relates to a mobile telephone call fee pre-payment registration system and device for performing pre-payment processing of a telephone call fee for a pre-paid mobile telephone, and performing registration processing for permitting use of the mobile telephone, and more particularly, to improvements in composition and control in order to enable telephone call permission registration of a mobile telephone by means of the simplest possible operations, when a telephone call fee is pre-paid.

### BACKGROUND ART

In order to prevent failure to pay telephone call fees by a foreign traveler residing in the country for a short period of time, or in order to popularize use amongst children who do not have payment capacity, mobile telephones for exclusive use with telephone call fee pre-payment systems have been developed by respective mobile telephone manufacturers.

In order to use a mobile telephone for exclusive use with a telephone call fee pre-payment system of this kind, it is a prerequisite that a telephone call fee is paid in advance and that the identification information of the mobile telephone is then registered with a registration center, before calls can be made with that mobile telephone.

In current pre-payment systems designed for mobile telephones of this kind for exclusive use with telephone call fee pre-payment systems, the mobile telephone is registered in order to permit calls to be made using that telephone by performing the actions of purchasing a card bearing a unique number which is concealed by a scratchable covering, or the like, confirming the unique number printed on the card by removing the scratchable covering, or the like, and then registering that unique number with a registration center.

Consequently, if the user of a mobile telephone for exclusive use with a telephone call-fee pre-payment system seeks to register the mobile telephone in order to be able to make telephone calls using that telephone, then he or she is required to perform complicated operations, such as manually inputting a large number of digits corresponding to the unique number, and hence human input errors are liable to occur.

In this way, in a conventional pre-payment system for registering a mobile telephone for exclusive use with a telephone call fee pre-payment system, in order that it can be used to make calls, after making pre-payment of a telephone call fee of a particular amount by purchasing a card corresponding to the desired amount, the user then registers the unique number printed on that card with a registration center by manually inputting the number, and hence the registration operation is extremely complicated and input errors are liable to occur.

### SUMMARY OF THE INVENTION

Therefore, it is an object of the present invention to resolve the aforementioned problems by providing a telephone call fee pre-payment registration system and device for mobile telephones capable of performing telephone call permission registration without requiring complicated input operations and without giving rise to input errors.

In order to achieve the aforementioned objects, the invention according to claim 1 is a mobile telephone call fee pre-payment registration system comprising: a pre-paid mobile telephone terminal; a registration center device for performing telephone call permission registration of the mobile telephone terminal by using identification information of the mobile telephone terminal and information relating to a pre-paid telephone call fee; and a registration device for performing pre-payment processing for a telephone call fee for the mobile telephone terminal, and registration processing for the telephone call permission registration of the mobile telephone terminal to register the mobile telephone terminal in order, with the registration center device; wherein the mobile telephone terminal comprises: communications means for communicating with the registration device; and control means for sending identification information relating to that mobile telephone terminal, to the registration device via the communications means; the registration device comprises: money deposit processing means for processing the depositing of money corresponding to a telephone call fee that is to be pre-paid; first communications means for communicating with the mobile telephone terminal; second communications means for communicating with the registration center device; and control means for obtaining identification information for the terminal from the mobile telephone terminal, via the first communications means, and sending the identification information thus obtained and money deposit information processed by the money deposit processing means, to the registration center device, via the second communications means; and the registration center device comprises: communications means for communicating with the second communications means of the registration device; and control means for conducting the telephone call permission registration, in accordance with the money deposit information and the identification information received from the registration device via the communications means.

The invention according to claim 2 is the invention according to claim 1, wherein the communications means of the mobile telephone terminal and the first communications means of the registration device are infrared communications means performing communications by means of infrared.

The invention according to claim 3 is the invention according to claim 1, wherein the communications means of the mobile telephone terminal and the first communications means of the registration device are short-distance wireless communications means performing communications based on a short-distance wireless communications system.

The invention according to claim 4 is the invention according to claim 1, wherein the communications means of the mobile telephone terminal and the first communications means of the registration device are wired communications means performing communications based on a wired communications system.

The invention according to claim 5 is a mobile telephone call fee pre-payment registration device for performing a pre-payment processing of a telephone call fee of a pre-paid mobile telephone terminal, and for performing a registration processing of information required for telephone call permission registration of the mobile telephone terminal, with a registration center device; comprising: money deposit processing means for processing the depositing of money corresponding to a telephone call fee that is to be pre-paid; first communications means for communicating with the mobile telephone terminal; second communications means for communicating with the registration center device; and control means for obtaining identification information for the terminal from the mobile telephone terminal, via the first communications means, and sending the identification information thus obtained and money deposit information processed by the money deposit processing means, to the registration center device, via the second communications means.

The invention according to claim 6 is the invention according to claim 5, wherein the first communications means is infrared communications means for performing communications by means of infrared. The invention according to claim 7 is the invention according to claim 5, wherein the first communications means is short-distance wireless communications means for performing communications by means of a short-distance wireless communications system.

The invention according to claim 8 is the invention according to claim 5, wherein the first communications means is wired communications means for performing communications by means of a wired communications system.

According to the configuration of the present invention, since money deposit processing means for processing the depositing of money corresponding to a value of a telephone call fee that is to be pre-paid, first communications means for communicating with a mobile telephone terminal and second communications means for communicating with a registration center device are provided, and since identification information is obtained from the mobile telephone terminal via the first communications means, and the identification information thus obtained is sent, together with the money deposit information processed by the money deposit processing means, to the registration center device, via the second communications means, then the user carrying a mobile telephone terminal is able to automatically perform the telephone call permission registration of the mobile telephone terminal, simply by making pre-payment of a telephone call fee by depositing money corresponding to the desired telephone call fee into the money deposit processing means, using currency or a pre-paid card, or the like.

### BRIEF DESCRIPTION OF THE DRAWINGS

FIG. 1 is a diagram showing the general composition of a mobile telephone call fee pre-payment registration system relating to the present invention;

FIG. 2 is a block diagram showing the functional composition of the mobile telephone terminal in FIG. 1;

FIG. 3 is a block diagram showing the functional composition of the telephone call fee pre-payment registration device in FIG. 1;

FIG. 4 is a block diagram showing the functional composition of the registration center device in FIG. 1;

FIG. 5 is a diagram showing the sequence of processing for registering telephone call fee pre-payment for a mobile telephone terminal in the system illustrated in FIG. 1; and

FIG. 6 is a diagram showing an image of a telephone call using the mobile telephone terminal after registration of the telephone call fee pre-payment has been completed.

### BEST MODE FOR CARRYING OUT THE INVENTION

Below, embodiments of the present invention are described in detail with reference to the accompanying drawings.

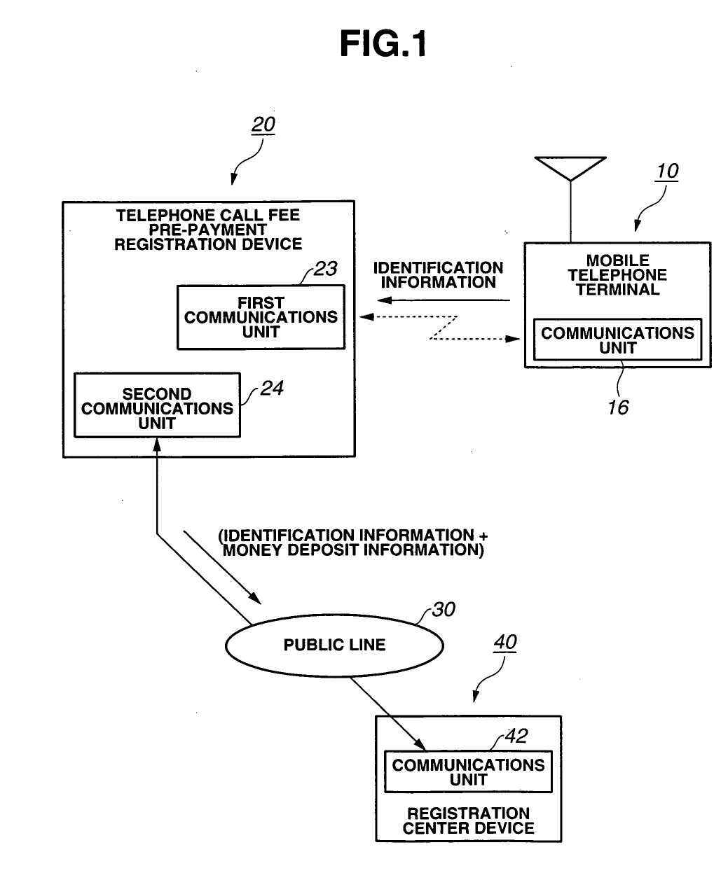

FIG. 1 is a diagram showing the general composition of a mobile telephone call fee pre-payment registration system relating to the present invention.

In FIG. 1, the mobile telephone call fee pre-payment registration system comprises: a pre-paid mobile telephone terminal 10, which is carried by a user; a telephone call fee pre-payment registration device for mobile telephones (hereinafter, abbreviated to “registration device”) 20 which performs telephone call fee pre-payment processing for the mobile telephone terminal 10, and supplies information relating to telephone call permission registration of the mobile telephone terminal 10 using the pre-paid telephone call fee, to a registration center device 40; and a registration center device 40, connected to the registration device 20 via a public line 30, for performing processing of telephone call permission registration of the mobile telephone terminal 10, on the basis of the aforementioned information supplied by the registration device 20 via the public line 30.

In this system, the mobile telephone terminal 10 is a pre-paid telephone terminal, wherein a telephone call fee is pre-paid, and calls can be made for the time period corresponding to the pre-paid telephone call fee.

In order to use a pre-paid mobile telephone terminal 10 of this kind to make a call for a time period corresponding to the pre-paid telephone call fee, it is necessary not only to pre-pay the telephone call fee, but also to register the identification information of the mobile telephone terminal 10 in association with information relating to the pre-paid telephone call fee, with the registration center device 40 (telephone call permission registration).

The registration device 20 carries out processing for pre-payment of a telephone call fee required for the telephone call permission registration of the mobile telephone terminal 10, and furthermore, it sends information relating to the pre-paid telephone call fee and identification information for the mobile telephone terminal 10 that is to make calls using that telephone call fee, to the registration center device 40 via the public line 30.

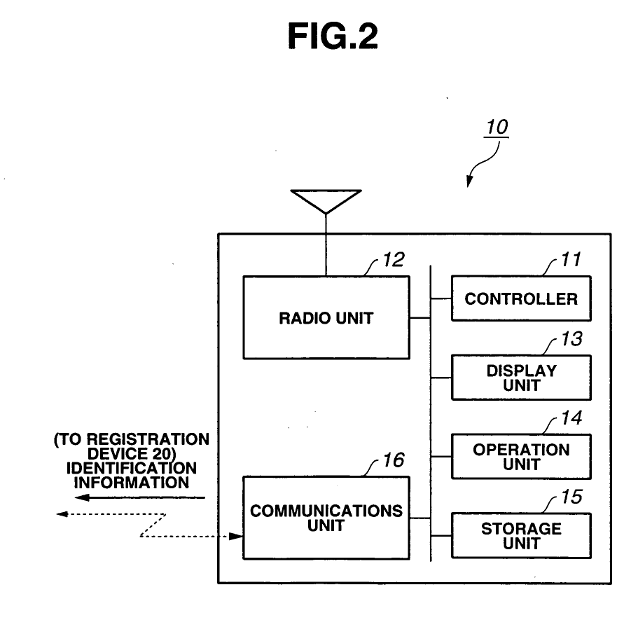

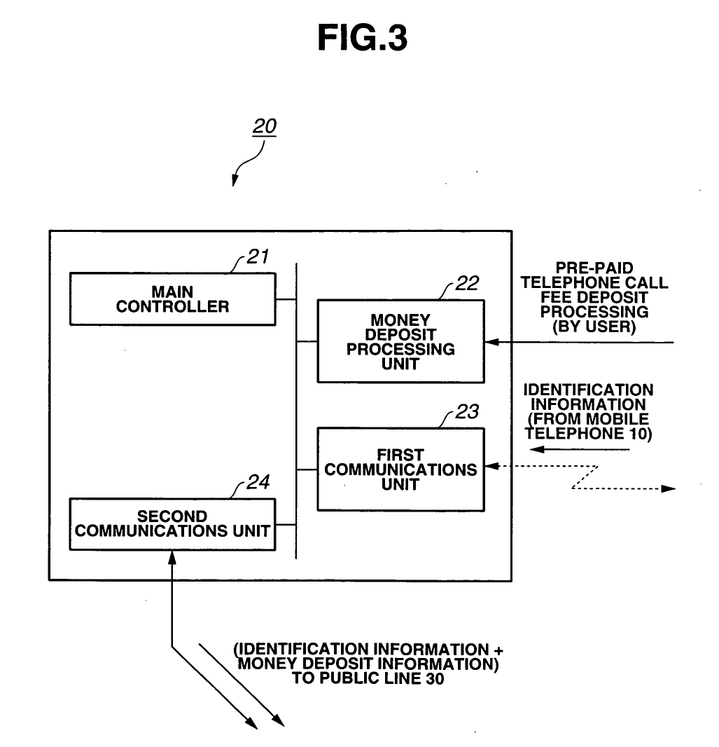

In this case, the registration device 20 obtains identification information from the mobile telephone terminal 10 by means of a communications device (corresponding to the first communications unit 23 in FIG. 3) provided in order to communicate with a communications device provided in the mobile telephone terminal 10 (corresponding to communications unit 16 in FIG. 2).

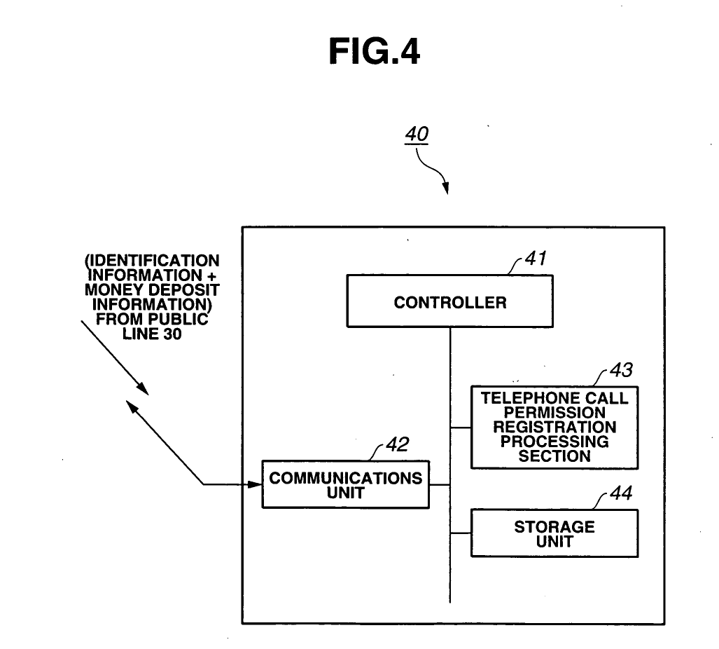

Furthermore, the registration device 20 sends the telephone call fee information (money deposit information) relating the aforementioned pre-payment process, and identification information obtained from the mobile telephone terminal 10, to the registration center device 40 via the public line 30, by means of a communications device (corresponding to the second communications unit 24 in FIG. 3) provided in order to communicate with the communications device provided in the registration center device 40 (corresponding to the communications unit 42 in FIG. 4).

By storing the aforementioned money deposit information and identification information sent by the registration device 20 via the public line 30, in a mutually associated fashion, the registration center device 40 carries out processing for performing registration in such a manner that calls can be made using the mobile telephone terminal 10 identified by the identification information (telephone call permission registration processing).

Next, the composition of the respective devices in the system in FIG. 1 will be described.

FIG. 2 is a block diagram showing the functional composition of the mobile telephone terminal 10 in the system illustrated in FIG. 1.

In FIG. 2, the mobile telephone terminal 10 comprises a controller 11, a radio unit 12, a display unit 13, an operating unit 14, and a storage unit 15 (each of these units having the same functions and composition as a general mobile telephone terminal), and in addition to these, it also comprises a communications unit 16 for communicating with the first communications unit 23 of the registration device 20, which is described later.

The mobile telephone terminal 10 may naturally be used as a mobile radio telephone terminal, such as a car telephone, but it is not limited to this and may also be used as a PHS.

Whatever the type of system in which the mobile telephone terminal 10 is used, the mobile telephone terminal 10 is a pre-paid telephone terminal which can only make calls corresponding to a pre-paid telephone call fee.

In other words, the mobile telephone terminal 10 is only permitted to make calls once a telephone call fee has been pre-paid and information relating to this pre-paid telephone call fee and identification information for the mobile telephone terminal 10 that is to use the telephone call fee has been registered in the registration center device 40 (telephone call permission registration).

In the mobile telephone terminal 10 relating to the present invention, identification information relating to the terminal is stored in the storage unit 15, and the controller 11 has a control function for reading out the identification information from the storage unit 15, in response to a request from the registration device 20, for example, and sending that information to the registration device 20, by means of the communications unit 16.

FIG. 3 is a block diagram showing the functional composition of the registration device 20 in the system illustrated in FIG. 1.

In FIG. 3, the registration device 20 comprises a main controller 21, a money deposit processing unit 22, a first communications unit 23, and a second communications unit 24.

The money deposit processing unit 22 is a functional part for receiving the deposit of money corresponding to a pre-paid telephone call fee, and it is constituted, for example, by a coin processing device for handling coins, or a banknote processing device for handling bank notes, or the like. Apart from this, the money deposit processing unit 22 may also be composed so as to receive the deposit of money corresponding to a pre-paid telephone call fee, by receiving a pre-paid type card, a credit card, a J.C. coin, or the like.

The money deposit processing unit 22 comprises currency input slots for inputting coins or banknotes, a card input slot for inputting pre-paid type cards, and the like, and an output opening for outputting change, and it also includes an operating unit, such as an amount button, for selecting the amount of the pre-paid telephone call fee that can be processed (purchased) via the device, and a display unit for displaying various information, such as operation and registration advice relating to the telephone call fee pre-payment system.

The first communications unit 23 is a functional part for communicating with the communications unit 16 of the mobile telephone terminal 10 for which telephone call fee pre-payment is to be registered, and more particularly, it has a communications control function for obtaining identification information relating to the mobile telephone terminal 10, from the mobile telephone terminal 10 by means of the communications unit 16.

In specific examples, the first communications unit 23 can be realized, for example, by wired communications means performing wired communications by providing a cable and connector (the connection terminal of the mobile telephone terminal 10 being connectable to this connector terminal), by short-distance wireless communications means performing short-distance wireless communications based on Bluetooth (R) standards, by non-contact type IC card communications standards, by infrared communications means performing communications by means of infrared, or by a combination of a plurality of these communications means.

The communications section 16 of the mobile telephone terminal 10 which communicates with the first communications section 23 also has a communications interface similar to that of the first communications section 23.

The second communications unit 24 is a functional part for communicating with the registration center device 40 via the public line 30, and more particularly, it has a communications control function for sending and receiving information required to register the mobile telephone terminal 10 for which telephone call fee pre-payment is to be registered in order that the telephone is permitted to make calls (namely, money deposit information and identification information).

The main controller 21 is a functional part for controlling the respective units, such as the aforementioned money deposit processing unit 22, first communications unit 23 and second communications unit 24, and it performs control relating to money deposit processing for pre-payment of a telephone call fee by the user of the mobile telephone terminal 10 for which the telephone call fee pre-payment is to be registered, and to processing for registering the money deposit information relating to this money deposit processing (the amount information of the telephone call fee pre-paid by the user) and the identification information of the mobile telephone terminal 10, in a mutually associated fashion, in the registration center device 40 (telephone call permission registration).

More specifically, for example, when the user deposits money into the money deposit processing unit 22, by means of currency, a pre-paid card, or the like, and then presses an amount button corresponding to a desired pre-paid telephone call fee, then the controller 21 performs control for recognizing information indicating the amount of money deposited at the time that the button is pressed (money deposit information), obtaining the identification information of the terminal 10 from the mobile telephone terminal 10 via the first communications unit 23, when the amount button is depressed, and sending the identification information thus obtained and the money deposit information recognized in the money deposit processing performed by the money deposit processing unit 22, from the second communications unit 24 to the registration center device 40, by means of the public line 30.

FIG. 4 is a block diagram showing the functional composition of the registration center device 40 in the system illustrated in FIG. 1.

The registration center device 40 is a computer installed in a registration center by a telecommunications operator providing mobile telephone services based on a telephone call fee pre-payment system.

In FIG. 4, the registration center device 40 comprises: a controller 41 for controlling the whole device; a communications unit 42 having a communications control function for receiving money deposit information and identification information sent by the second communications unit 24 of the registration device 20; a registration for call permission processing unit 43 for carrying out processing for the telephone call permission registering of the mobile telephone terminal 10 identified by the identification information in accordance with the aforementioned money deposit information and identification information received by the communications unit 42; and a storage unit 44 for storing various information such as information required for the telephone call permission registration (money deposit information and identification information).

Next, an operation for registering telephone call fee pre-payment for a mobile telephone terminal 10 in the system relating to the present invention (see FIG. 1) will be described.

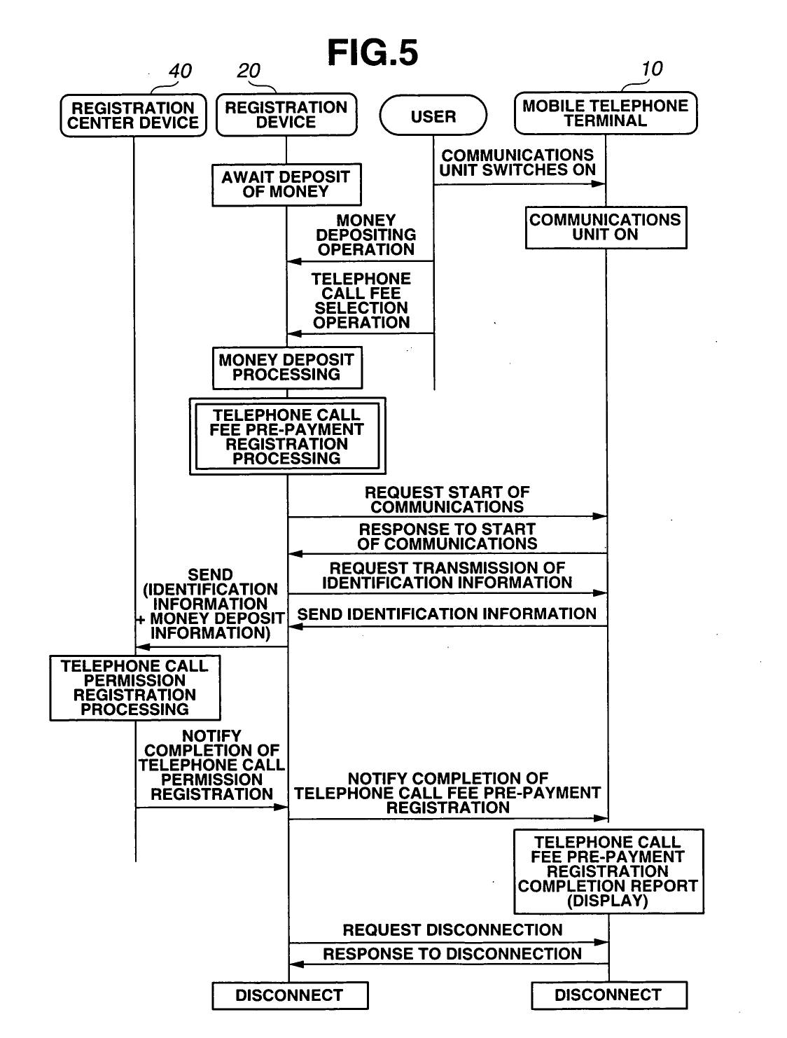

FIG. 5 is a diagram showing the sequence of processing relating to registration of telephone call fee pre-payment for a mobile telephone terminal 10 in the system illustrated in FIG. 1.

As shown in FIG. 5, when telephone call fee pre-payment is to be registered for the mobile telephone terminal 10, firstly, the user performs an operation for switching the communications unit 16 to ON, by means of the operating section 14 of the mobile telephone terminal 10.

By switching the communications unit on in this way, the controller 11 of the mobile telephone terminal 10 sets the communications unit 16 to an ON state.

Next, the user performs an operation (a money depositing operation) in which he or she inserts money sufficient to cover a desired pre-paid telephone call fee into the currency input slot of the money deposit processing unit 22 of the registration device 20, or inserts a pre-paid type card, or the like, into a card insertion slot of the money deposit processing unit 22, whereupon the user performs an operation of selecting a desired pre-paid telephone call fee (a telephone call fee selection operation).

In this case, the main controller 21 of the registration device 20 causes, for example, the amount buttons corresponding to telephone call fees equal to or less than the amount of money that has been deposited into the money deposit processing unit 22 to light up. The user carries out the aforementioned telephone call fee selection operation by pressing the amount button corresponding to the desired pre-paid telephone call fee, of the amount buttons that are lit up.

When the telephone call fee selection operation has been performed (when the amount button has been pressed), the main controller 21 of the registration device 20 carries out processing (money deposit processing) for recognizing information (money deposit information) indicating the amount of money that has been deposited into the money deposit processing unit 22 at the time that the amount button is pressed, and it then starts telephone call fee pre-payment registration processing based on the money deposit information thus processed.

In this telephone call fee pre-payment registration processing, the main controller 21 of the registration device 20 firstly sends a communications start request from the first communications unit 23 to the mobile telephone terminal 10 carried by the user.

Thereupon, the main controller 21 monitors whether or not a communications start response has been received from the mobile telephone terminal 10 by the first communications unit 23, and if a communications start response has been received, then it sends an identification information transmission request to the mobile telephone terminal 10 by means of the first communications unit 23.

Subsequently, the main controller 21 monitors whether or not identification information has been received from the mobile telephone terminal 10 via the first communications unit 23, and if identification information has been received, then it sends the identification information thus received and the money deposit information recognized in the aforementioned money deposit processing to the registration center device 40 by means of the second communications unit 24.

Thereupon, the main controller 21 monitors whether or not a telephone call permission registration completion report has been received from the registration center device 40 via the second communications unit 24, and if the telephone call permission registration completion report has been received, then it sends a telephone call fee pre-payment registration completion report to the mobile telephone terminal 10 by means of the first communications unit 23.

When this telephone call fee pre-payment registration completion report has been transmitted, the main controller 21 sends a disconnection request to the mobile telephone terminal 10 for which registration is being made, via the first communications unit 23, and upon receiving a disconnection response from the mobile telephone terminal 10 via the first communications unit 23, it disconnects the communication and ends the sequence of pre-paid telephone call fee registration processing.

During the telephone call fee pre-payment registration process in the registration device 20 described above, the controller 11 of the mobile telephone terminal 10 situated in front of the registration device 20 monitors whether or not a communications start request has been received from the first communications unit 23 of the registration device 20 via the communications unit 16, and if a communications start request has been received, then a communications start response is sent to the registration device 20, via the communications unit 16.

Thereupon, when an identification information transmission request sent by the registration device 20 is received by the communications unit 16, the controller 11 reads out the identification information for its own terminal from the storage unit 15 and sends that identification information to the registration device 20 via the communications unit 16.

Thereupon, when a telephone call fee pre-payment registration completion report sent by the registration device 20 is received by the communications unit 16, then a notification to this effect is displayed to the user on the display unit 13. Furthermore, if a disconnect request sent by the registration device 20 is subsequently received by the communications unit 16, then the controller 11 sends a disconnect response to the registration device 20 via the communications unit 16, disconnects the communication and terminates processing.

On the other hand, when pre-payment of a telephone call fee is registered at the registration device 20 described above, in the registration center device 40, the controller 41 starts up the registration for call permission processing unit 43 and carries out call permission registration processing, when the aforementioned money deposit information and identification information sent by the second communications unit 24 of the registration device 20 is received by the communications unit 42.

In this telephone call permission registration processing, the controller 41 sends the money deposit information and identification information received from the registration device 20 by the communications unit 42, to the telephone call permission registration processing unit 43. The telephone call permission registration processing unit 43 stores the money deposit information and the identification information received from the registration device 20, in a mutually associated fashion, in the storage unit 44.

When the call permission registration processing has been completed, namely, when the money deposit information and the identification information have been stored in a mutually associated fashion in the storage unit 44, then the controller 41 sends a call permission registration completion report to the registration device 20 by means of the communications unit 42.

When the registration of telephone call fee pre-payment has been completed in the mobile telephone terminal 10 in accordance with the processing sequence illustrated in FIG. 5, that mobile telephone terminal 10 becomes able to make calls for a period of time corresponding to the telephone call fee that has been paid by means of the registration device 20.

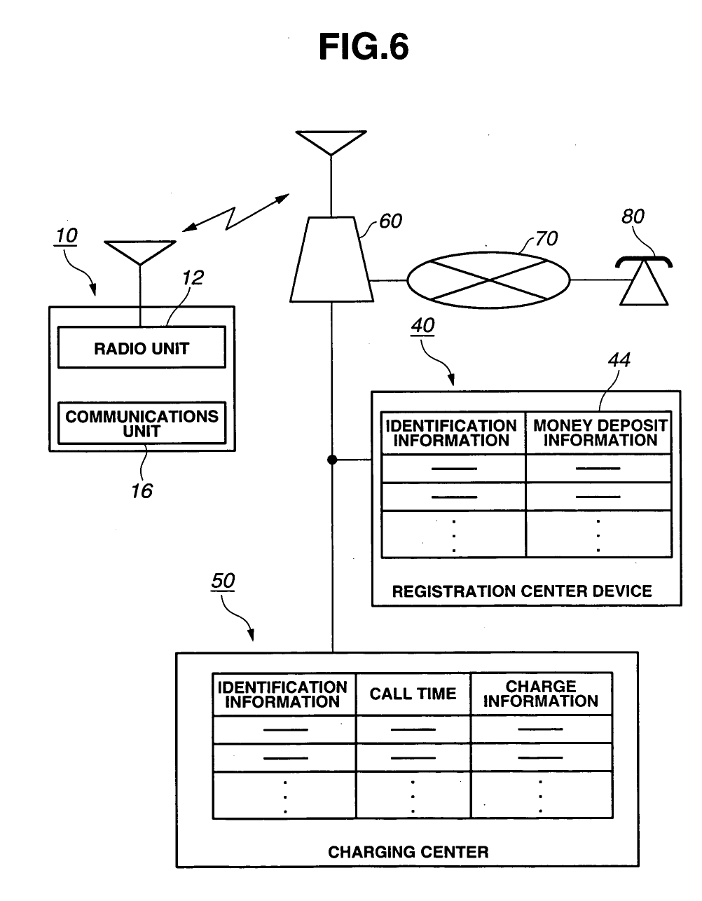

FIG. 6 is a diagram showing an image of a telephone call using the mobile telephone terminal 10 after registration of telephone call fee pre-payment has been completed.

In particular, FIG. 6 shows a state where the mobile telephone terminal 10 is communicating with a mobile telephone 80 connected to a wired circuit 70, by means of radio communications between the radio unit 12 and a base station 60.

In this case, if a call is initiated by the mobile telephone terminal 10, then the base station 60 controls the connection of the mobile telephone terminal 10 to the mobile telephone 80, by proceeding to search the telephone call permission registration information stored in the storage unit 44 of the registration center device 40 and by confirming that identification information corresponding to the mobile telephone terminal 10 originating the call has been registered and that the corresponding money deposit information is not “0”.

After establishing a connection, the charging center 50 monitors the call time of the mobile telephone terminal 10, and each time a prescribed payment unit time period has elapsed, it generates charge information corresponding to the call time up to that point and sends this charge information to the registration center device 40, together with the identification information of the mobile telephone terminal 10 for which this charge information is being communicated.

On the basis of the identification information and the charge information sent by the charging center 50, the registration center device 40 deducts an amount of money corresponding to the charge information, from the money deposit information corresponding to that identification information, and executes processing for updating the money deposit information with the result of this deduction operation, each time the aforementioned payment unit time period has elapsed.

Thereupon, the registration center device 40 and the charging center 50 continue to perform similar processing to the foregoing, while the mobile telephone terminal 10 is making the call, and they allow the call to continue, provided that the remaining amount obtained when the charge information is deducted from the money deposit information at a unit payment time period is not “0”. If the remaining amount becomes “0” during the call, then control is implemented in such a manner that the call is terminated immediately.

In this way, the telephone call fee pre-payment registration system relating to the present invention comprises functions whereby, when a user of a mobile telephone terminal 10 that is to be registered implements money deposit processing for a pre-paid telephone call fee at a registration device 20, the registration device 20 obtains identification information from the mobile telephone terminal 10, and sends the identification information and money deposit information recognized during the money deposit processing to the registration center device 40.

According to this configuration, by means of the user simply depositing currency (or using a pre-paid card to deposit money) corresponding to a desired telephone call fee, into a registration device 20, and then making an amount selection, using exactly the same actions as if he or she were purchasing a product from an automatic vending machine, it is possible to make pre-payment of a telephone call fee and to register information (money deposit information) relating to the pre-paid telephone call fee, as well as the identification information of the mobile telephone terminal 10 that is to use that telephone call fee, in a mutually associated fashion in the registration center device 40.

By this means, the operations of purchasing a card of an amount corresponding to the pre-paid telephone call fee and then manually inputting the number printed on the card, which are required for the telephone call permission registration in a conventional system, become completely unnecessary. Therefore, from the user's viewpoint, no complicated registration operations are required and there is no risk of input errors, whilst from the viewpoint of a telecommunications operator providing a mobile telephone service based on pre-payment of telephone call fees, there is no need to issue cards and hence costs can be reduced.

The present invention is not limited to the embodiment described above and illustrated in the drawings, and the invention may be implemented in suitably modified form, provided that the essence of the invention is not changed.

For example, the communications control sequence for obtaining identification information from the mobile telephone terminal 10 that is being registered by the registration device 20 is not limited to a method where a communications start request is issued by the first communications unit 23 of the registration device 20, as described in the aforementioned embodiments, and it is also possible for a communications start request to be issued by the communications unit 16 of the mobile telephone terminal 10, whilst also sending the identification information of the terminal.

Furthermore, the timing at which the registration device 20 obtains identification information from the mobile telephone terminal 10 that is to be registered is not limited to a timing after the operations of depositing money and selecting a telephone call fee have been conducted, and it is also possible for the identification information to be obtained before the operations of depositing money and selecting a telephone call fee have been conducted.

Moreover, in the embodiments described above, it is a prerequisite that the communications unit 16 of the mobile telephone terminal 10 is in a switched on state when a communications start request is sent from the registration device 20 to the mobile telephone terminal 10, upon completion of the money depositing operation and telephone call fee selection operation by the user at the registration device 20, but the invention is not limited to this and, for example, an operation for switching on the communications unit 16 of the mobile telephone terminal 10 may be prompted to the user, by displaying guidance advising switching on of the communications unit 16 of the mobile telephone terminal 10, on the display unit (not illustrated) of the registration device 20, in cases where the communications unit 16 of the mobile telephone terminal 10 is in a switched off state when the aforementioned communications start request is sent, for example.

### INDUSTRIAL APPLICABILITY

Money deposit processing means for processing the depositing of money corresponding to the value of a telephone call fee that is to be pre-paid; first communications means for communicating with a mobile telephone terminal; and second communications means for communicating with the registration center device are provided. Identification information is obtained from the mobile telephone terminal via the first communications means, and the identification information thus obtained is sent, together with the money deposit information processed by the money deposit processing means, to the registration center device, via the second communications means. Therefore, the present invention is able to provide a telephone call fee pre-payment registration system and device for mobile telephones whereby the telephone call permission registration can be carried out without requiring complicated input operations and without the occurrence of input errors.

1. A mobile telephone call fee pre-payment registration system comprising: a pre-paid mobile telephone terminal; a registration center device for performing telephone call permission registration of the mobile telephone terminal by using identification information of the mobile telephone terminal and information relating to a pre-paid telephone call fee; and a registration device for performing pre-payment processing for a telephone call fee for the mobile telephone terminal, and registration processing for the telephone call permission registration of the mobile telephone terminal to register the mobile telephone terminal in order, with the registration center device;
wherein the mobile telephone terminal comprises:
communications means for communicating with the registration device; and
control means for sending identification information relating to that mobile telephone terminal, to the registration device via the communications means;
the registration device comprises:
money deposit processing means for processing the depositing of money corresponding to a telephone call fee that is to be pre-paid;
first communications means for communicating with the mobile telephone terminal;
second communications means for communicating with the registration center device; and
control means for obtaining identification information for the terminal from the mobile telephone terminal, via the first communications means, and sending the identification information thus obtained and money deposit information processed by the money deposit processing means, to the registration center device, via the second communications means; and
the registration center device comprises:
communications means for communicating with the second communications means of the registration device; and
control means for conducting the telephone call permission registration, in accordance with the money deposit information and the identification information received from the registration device via the communications means.

2. The mobile telephone call fee pre-payment registration system according to claim 1, wherein the communications means of the mobile telephone terminal and the first communications means of the registration device are infrared communications means performing communications by means of infrared.

3. The mobile telephone call fee pre-payment registration system according to claim 1, wherein the communications means of the mobile telephone terminal and the first communications means of the registration device are short-distance wireless communications means performing communications based on a short-distance wireless communications system.

4. The mobile telephone call fee pre-payment registration system according to claim 1, wherein the communications means of the mobile telephone terminal and the first communications means of the registration device are wired communications means performing communications based on a wired communications system.

5. A mobile telephone call fee pre-payment registration device for performing a pre-payment processing of a telephone call fee of a pre-paid mobile telephone terminal, and for performing a registration processing of information required for telephone call permission registration of the mobile telephone terminal, with a registration center device; comprising:
money deposit processing means for processing the depositing of money corresponding to a telephone call fee that is to be pre-paid;
first communications means for communicating with the mobile telephone terminal;
second communications means for communicating with the registration center device; and
control means for obtaining identification information for the terminal from the mobile telephone terminal, via the first communications means, and sending the identification information thus obtained and money deposit information processed by the money deposit processing means, to the registration center device, via the second communications means.

6. The mobile telephone call fee pre-payment registration device according to claim 5, wherein the first communications means is infrared communications means for performing communications by means of infrared.

7. The mobile telephone call fee pre-payment registration device according to claim 5, wherein the first communications means is short-distance wireless communications means for performing communications by means of a short-distance wireless communications system.

8. The mobile telephone call fee pre-payment registration device according to claim 5, wherein the first communications means is wired communications means for performing communications by means of a wired communications system.
